(19) United States
(12) Patent Application Publication
(10) Pub. No.: US 2009/0156433 A1
(43) Pub. Date: Jun. 18, 2009

(54) HF acidizing compositions and methods for improved placement in a subterranean formation to remediate formation damage

(76) Inventors: Amare Mebratu, Stavanger (NO); Olav Martin Selle, Jakobsli (NO)

Correspondence Address: ROBERT A. KENT, P.O. BOX 1431, DUNCAN, OK, 73536, US

(21) Appl. No.: 12/001,833

(22) Filed: Dec. 12, 2007

(51) Int. Cl. C09K 8/68

(52) U.S. Cl. 507/213; 507/203

(57) ABSTRACT

According to the invention, a fully viscosified acid diversion system for hydrofluoric acid has been developed. The viscosifying agent comprises a xanthan polymer or a derivative thereof. A method of acidizing a portion of a subterranean formation is provided, the method comprising the steps of: (A) forming a viscosified treatment fluid comprising: (i) water; (ii) hydrogen fluoride or a controlled-release source of hydrogen fluoride; and (iii) a gelling agent comprising a xanthan polymer or derivative thereof; and (B) introducing the viscosified treatment fluid into the portion of the subterranean formation. A breaking agent can be used to achieve a controlled gel break time under downhole conditions. Other additives can also be included in the treatment fluid. A composition for use in treating a subterranean formation is also provided, the composition comprising: (A) water; (B) hydrogen fluoride or a controlled-release source of hydrogen fluoride; and (C) a gelling agent that comprises a xanthan or derivative thereof.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### TECHNICAL FIELD

The invention generally relates to chemical treatments to remediate damage to a subterranean formation penetrated by a wellbore. More particularly, the invention relates to viscosified treatment fluids, especially for HF acidizing treatments.

### BACKGROUND

The success of any chemical treatments to remediate formation damage critically depends on the placement efficiency.

In acidizing, the acid should be placed so that all potentially productive intervals accept a sufficient quantity of the total acid volume. If significant permeability, pressure, or formation damage variations are present in the interval to be treated, treatment fluid will enter the zones with the higher permeability, lower pressure, and least formation damage, leaving little fluid to treat the most damaged zone which can be potentially the most productive zone.

To achieve a more uniform fluid coverage, the original flow distribution across the interval often needs to be altered. The methods used to alter this flow distribution are called “diversion” methods. The purpose is to divert the flow of fluid from one portion of the interval being treated to another. The main objective here is not just to divert from high permeable formation to low permeable formation but from the undamaged to damaged formation or from the “thief” zone to the “target” zone.

The following is a brief description of some diversion technologies used in the industry. The use of coil tubing and jetting tools seems to be the industry preferred method to achieve improved placement of chemicals, however, due to the high cost associated with coiled tubing, bullheading is used dominantly. Other diversion techniques such as particulate diversion, ball sealer, and staged gel diversion are typically considered for different types of completions.

In particulate diversion, the use of particulates as a diverting material requires at least that: (A) the particulates should be soluble in the fluid produced from the well or fluid injected into the well after treatment; (B) the particulate material must have a melting point higher than the bottom hole treating temperature of the well; (C) the particulate must be sized correctly to function in the type of well completion in place; and (D) the particulate material must be compatible with the treatment fluid.

In stand alone screen completions and gravel packed wells, a special consideration has to be given to the size distribution of the particulate-diverting agents. The particles must be small enough to pass through the gravel pack screen and the gravel pack itself, yet still be large enough to form a filter cake at the formation face. Particulates (e.g. oil-soluble resin and benzoic acid) often exhibit less than ideal clean up behavior, particularly in the presence of polymers that inhibit the dissolution of the particulate in oil or water. The same thing applies for salts in oversaturated environment.

Ball sealers are generally not preferred in horizontal and deviated holes. The major influences on ball sealers efficiency in horizontal and deviated holes are hole angle, ball density, flow rate, perforation orientation, and permeability contrast. Floating ball sealers usually seat on the high side perforations and sinking ball sealers seat on the low side perforations. Neutrally buoyant ball sealers seat on top and bottom perforations and have a significant tendency to seat on the horizontally oriented perforations favoring 0° or 180° phased perforations. Ball sealers are simply not actual for completion types such as open hole, stand alone screen, gravel packed or pre-packed completions. In conclusion, their use is practically limited to short and vertical perforated wells.

Staged gel diversion is used in areas where the tubing volume is small. In small volume production tubing small stages of viscous fluid 1-5 m³ can be used without risking significant intermixing and dilution with the fluid behind and in front of it. Whereas, in a large volume tubular small viscous stages will be partially or completely diluted before they reach the target zone. Another challenge in using staged gel diversion is designing the exact volume required to isolate the thief zone selectively. This requires localizing the thief zone accurately and placing the diversion stage exactly within the range, which is usually a difficult task.

One area where staged gel diversion can be used with some degree of success is when the thief zone is located at the toe and where there is a long distance between the zones. In this case, a highly viscous gel will likely travel all the way down and prevent the treatment fluid from entering the thief zone. In a large tubing (50-100 m³), the size of the diverting stage needs to be large enough to reduce dilution. On the other hand it should be small enough not to block more than the thief zone. Again, making a staged gel diversion can be difficult.

Chemical diversion has been used in some cases.

U.S. Pat. No. 4,807,703 issued Feb. 28, 1989 having for named inventor Alfred R. Jennings, Jr. discloses in the Abstract thereof a process for acid treating a formation where a gelled and foamed acid pre-flush solution is utilized. Said pre-flush is injected into the formation under conditions and pressures sufficient to fracture said formation. Thereafter, a foamed acid solution is directed into the gelled and foamed acid pad. The resultant viscosity contrast causes the foamed acid to “finger” through said pad and unevenly etch the fracture face. “Fingering” of the foamed acid through said pad causes it to propagate substantially further into the formation than with existing sandstone acidizing processes.

The Society of Petroleum Engineers (“SPE”) Paper Number 90359-MS Titled “Gelled Organic Acid System for Improved CaCO₃ Removal in Horizontal Openhole Wells at the Heidrun Field” by authors Olav M. Selle, Rex M. S. Wat, Haavard Nasvik of Statoil; and Amare Mebratu, of Halliburton, published at the SPE Annual Technical Conference and Exhibition, 26-29 Sep., 2004, in Houston, Tex. discloses in the Abstract thereof that to remove calcium carbonate (CaCO₃) damage from openhole wells, proper contact with treatment fluids must occur. Poor results are often caused by the improper placement of acid. Such was the case in the horizontal, openhole wells with sand screens on the Heidrun Field (Norwegian Sea). In these wells, bullheading plain HCl acid to dissolve carbonate kill pills provided only temporary effectiveness. To provide a more even distribution of the acid treatment, a gelled organic acid system was developed. A purified xanthan polymer with an added breaker was selected for further evaluation. When used to viscosify HCl, the gel-breaking time of the xanthan gel was too short for bullheading applications at Heidrun. Subsequently, an organic acid blend with acceptable CaCO₃ dissolution power was formulated, and an environmentally acceptable corrosion inhibitor was incorporated.

It would be desirable to have new and improved chemical diversion techniques for HF acidizing in order to improve well treatment chemicals distribution along a production interval.

### SUMMARY OF THE INVENTION

According to the invention, a fully viscosified acid diversion system for hydrofluoric acid has been developed. The viscosifying agent comprises a xanthan polymer or a derivative thereof. A breaking agent can be used to achieve a controlled gel break time under downhole conditions.

More particularly, according to the invention a method of acidizing a portion of a subterranean formation comprises the steps of: (A) forming a viscosified treatment fluid comprising: (i) water; (ii) hydrogen fluoride or a controlled-release source of hydrogen fluoride; and (iii) a gelling agent comprising a xanthan polymer or derivative thereof; and (B) introducing the viscosified treatment fluid into the portion of the subterranean formation.

According to another aspect of the invention, a composition for use in treating a subterranean formation is provided, the composition comprising: (A) water; (B) hydrogen fluoride or a controlled-release source of hydrogen fluoride; and (C) a gelling agent that comprises a xanthan or derivative thereof.

### DETAILED DESCRIPTION OF A PREFERRED EMBODIMENT

As used herein, the words “comprise,” “has,” and “include” and all grammatical variations thereof are each intended to have an open, non-limiting meaning that does not exclude additional elements or steps.

The new approach is to viscosity the fines removal treatment chemical itself using xanthan polymer or derivative thereof so that the fluid becomes self diverting and more evenly distributed along the well interval, independent of completion types and well deviation.

The invention allows improved chemical placement efficiency by continuously diverting treatment fluids from high to low injectivity zones with or without the use of coiled tubing and to reduce the effect of crossflow in the well during shut-in.

The system does not require one to have a complete knowledge of the location of the thief zone, damaged zone, or the pressure and permeability distribution along the well. The viscous fluid will generally enter the highly injective zones at a higher rate than the rest. Then, the injectivity profile alters as the resistance to flow increases in the zones which have accepted significant amount of the viscous fluid.

The system can be advantageously used without particulate, which eliminates the potential for additional damage that can be caused by introduced solids, such as can occur with a particulate diversion. The absence of solids also makes it applicable in completion types including wells with screen in place.

The system can be deployed simply by bullheading. It does not require the use of coiled tubing. This will reduce a significant amount of cost.

This method is particularly beneficial in horizontal, open hole, and gravel packed or slotted liner wells, where many other diversion and selective placement techniques cannot be applied.

The method does not require any extra special equipment for mixing.

The viscosifing agent is environmentally friendly, and non-damaging to the formation.

The technology can be applied in any types of completion types, where an improved fluid distribution is desired.

An example of a suitable polymer for use in the invention is Halliburton's BIO-PAC. A particularly preferred xanthan polymer is a clarified or purified xanthan polymer, such as “WG-24” commercially available from Halliburton Energy Services, Duncan, Okla., USA. An example of a suitable breaker for use in the invention is Halliburton's SP-breaker™.

In certain embodiments, the present invention provides compositions and methods that are especially suitable for use in well bores comprising bottom-hole temperatures (“BHTs”) from about 30° F. to about 300° F. As known to one of ordinary skill in the art, the bottom hole circulating temperature can be below the BHT of the well bore, and may be reflective of the temperature of a treatment fluid during the treatment.

One advantage of the many advantages of the fluids of the present invention is that they are sheer thinning fluids.

The viscosified treatment fluids of the present invention generally comprise a water, hydrogen fluoride (“HF”), and a gelling agent that comprises a xanthan or derivative thereof. Xanthans clean up better than guar or hydroxyethylcellulose (“HEC”) based fluids, which usually gives them better regains. In certain preferred embodiments, the viscosified treatment fluids of the present invention comprise a brine of ammonium chloride.

Preferably only freshwater or a brine made of ammonium chloride should be used because many other types of cations in salts will precipitate HF as insoluble fluorides. In addition, certain types of xanthans hydrate better in freshwater prior to mixing with a brine or adding an inorganic salt.

The viscosified treatment fluids of the present invention may vary widely in density. One of ordinary skill in the art with the benefit of this disclosure will recognize the particular density that is most appropriate for a particular application. In certain preferred embodiments, the viscosified treatment fluids of the present invention will have a density of about 8.3 pounds per gallon (“ppg”) to about 19.2 ppg. The desired density for a particular viscosified treatment fluid may depend on characteristics of the subterranean formation, including, inter alia, the hydrostatic pressure required to control the fluids of the subterranean formation during placement of the viscosified treatment fluids, and the hydrostatic pressure that will damage the subterranean formation. The types of salts or brines used to achieve the desired density of the viscosified treatment fluid are limited by compatibility with HF. Availability and environmental impact also may affect this choice.

The hydrogen fluoride can be provided as a controlled-release source of hydrogen fluoride. Although HF can be generated by adding a source of HF to water, such as an HF-salt, such HF-salts tend to be hygroscopic and to react in an uncontrolled manner with water. It is believed, however, that a controlled-release of an HF-salt can be achieved with encapsulation or other delay-release techniques that are well known in the art. For example, it is believed that an HF-salt such as ammonium hydrogen fluoride (which is also known as ammonium bifluoride) can be encapsulated such that the HF-salt is released in a controlled manner. For example, the encapsulating material can be selected to dissolve at a particular temperature to release the HF-salt or it can be selected to dissolve gradually over time, or both. Suitable encapsulation methods are known to those skilled in the art and discussed in more detail below.

The hydrogen fluoride is preferably included in the viscosified treatment fluid in an amount from about 0.5% to about 10% by weight of the water, and more preferably in the range of about 0.5% to about 3% by weight of the water.

The gelling agents used in the viscosified treatment fluids of the present invention comprise a xanthan or a xanthan derivative. Suitable xanthans generally exhibit pseudoplastic rheology (shear reversible behavior). Suitable xanthans also are generally soluble in hot or cold water, and are stable over a range of pHs and temperatures. Additionally, suitable xanthans are preferably compatible with and stable in systems containing salts. Moreover, suitable xanthans should provide good suspension for particulates often used in subterranean applications, such as proppant, sand, or gravel.

Preferred xanthans should have good filterability. For instance, a desirable xanthan should have a flow rate of at least about 200 ml in 2 minutes at ambient temperature in a filtering laboratory test on a Baroid Filter Press using 40 psi of differential pressure and an 11 cm Whatman filter paper having a 2.7 micrometer pore size.

The amount of gelling agent used in the viscosified treatment fluids of the present invention can vary from about 20 lb/Mgal to about 100 lb/Mgal. In other embodiments, the amount of gelling agent included in the treatment fluids of the present invention can vary from about 30 lb/Mgal to about 80 lb/Mgal. In a preferred embodiment, about 60 lb/Mgal of a gelling agent is included in an embodiment of a treatment fluid of the present invention. It should be noted that in well bores having BHTs of 200° F. or more, 70 lbs/Mgal or more of the gelling agent can be beneficially used in a treatment fluid of the present invention.

Optionally, the gelling agents of the present invention can comprise an additional biopolymer if the use of the xanthan and the biopolymer produces a desirable result, e.g., a synergistic effect. Suitable biopolymers can include polysaccharides and/or derivatives thereof. Depending on the application, one biopolymer may be more suitable than another. One of ordinary skill in the art with the benefit of this disclosure will be able to determine if a biopolymer should be included for a particular application based on, for example, the desired viscosity of the viscosified treatment fluid and the bottom hole temperature (“BHT”) of the well bore.

If a brine is used, ammonium chloride brine is preferred and, where used, can be of any weight within the maximum saturation limit.

In certain embodiments, the viscosified treatment fluids of the present invention also can comprise additives, including without limitation, salts, pH control additives, surfactants, breakers, bactericides, crosslinkers, fluid loss control additives, stabilizers, chelants, scale inhibitors, corrosion inhibitors, non-emulsifiers, surfactants, combinations thereof, or the like, provided that the additive is compatible with HF and the xanthan gelling agent.

An appropriate salt that does not react with HF, such as ammonium chloride, can be included in the viscosified treatment fluids of the present invention for many purposes, including, densifying the fluid to achieve a chosen density. Such salt also can be included for reasons related to compatibility of the viscosified treatment fluid with the formation and formation fluids. To determine whether a salt can be beneficially used for compatibility purposes, a compatibility test may be performed to identify potential compatibility problems. From such tests, one of ordinary skill in the art with the benefit of this disclosure will be able to determine whether and what salt should be included in a viscosified treatment fluid of the present invention. A suitable salt includes ammonium chloride. The amount of the salt that should be added should be the amount needed to take the viscosified treatment fluid to the required density, taking into consideration the crystallization temperature of the brine, e.g., the temperature at which the salt precipitates from the brine as the temperature drops.

In some embodiments, the viscosified treatment fluids of the present invention can include surfactants, e.g., to improve the compatibility of the viscosified treatment fluids of the present invention with other fluids (like any formation fluids) that may be present in the well bore. An artisan of ordinary skill with the benefit of this disclosure will be able to identify the type of surfactant as well as the appropriate concentration of surfactant to be used. Suitable surfactants can be used in a liquid or powder form. Where used, the surfactants are present in the viscosified treatment fluid in an amount sufficient to prevent incompatibility with formation fluids or well bore fluids. In an embodiment where liquid surfactants are used, the surfactants are generally present in an amount in the range of from about 0.01% to about 5.0% by volume of the viscosified treatment fluid. In one embodiment, the liquid surfactants are present in an amount in the range of from about 0.1% to about 2.0% by volume of the viscosified treatment fluid. In embodiments where powdered surfactants are used, the surfactants can be present in an amount in the range of from about 0.001% to about 0.5% by weight of the viscosified treatment fluid. Examples of suitable surfactants are non-emulsifiers commercially available from Halliburton Energy Services, Inc., of Duncan, Okla., under the trade names “LOSURF-259™” nonionic non-emulsifier, “LOSURF-300™” nonionic surfactant, “LOSURF-357™”, nonionic surfactant, and “LOSURF-400™” surfactant. Another example of a suitable surfactant is a non-emulsifier commercially available from Halliburton Energy Services, Inc., of Duncan, Okla., under the trade name “NEA-96M™”, Surfactant. It should be noted that it can be beneficial to add a surfactant to a viscosified treatment fluid of the present invention as that fluid is being pumped downhole to help eliminate the possibility of foaming.

In some embodiments, the viscosified treatment fluids of the present invention can contain bactericides, inter alia, to protect both the subterranean formation as well as the viscosified treatment fluid from attack by bacteria. Such attacks may be problematic because they may lower the viscosity of the viscosified treatment fluid, resulting in poorer performance, such as poorer sand suspension properties, for example. Any bactericides known in the art are suitable. An artisan of ordinary skill with the benefit of this disclosure will be able to identify a suitable bactericide and the proper concentration of such bactericide for a given application. Where used, such bactericides are present in an amount sufficient to destroy all bacteria that may be present. Examples of suitable bactericides include, but are not limited to, a 2,2-dibromo-3-nitrilopropionamide, commercially available under the trade name “BE-3S™” biocide from Halliburton Energy Services, Inc., of Duncan, Okla., and a 2-bromo-2-nitro-1,3-propanediol commercially available under the trade name “BE-6™” biocide from Halliburton Energy Services, Inc., of Duncan, Okla. In one embodiment, the bactericides are present in the viscosified treatment fluid in an amount in the range of from about 0.001% to about 0.003% by weight of the viscosified treatment fluid. Another example of a suitable bactericide is a solution of sodium hypochlorite, commercially available under the tradename “CAT-1™” chemical from Halliburton Energy Services, Inc., of Duncan, Okla. In certain embodiments, such bactericides can be present in the viscosified treatment fluid in an amount in the range of from about 0.01% to about 0.1% by volume of the viscosified treatment fluid. In certain preferred embodiments, when bactericides are used in the viscosified treatment fluids of the present invention, they are added to the viscosified treatment fluid before the gelling agent is added.

The viscosified treatment fluids of the present invention also optionally can comprise a suitable crosslinker to crosslink the xanthan of the gelling agent in the viscosified treatment fluid. Crosslinking can be desirable at higher temperatures and/or when the sand suspension properties of a particular fluid of the present invention may need to be altered for a particular purpose. Any crosslinker that is compatible with the xanthan in the gelling agent, the HF, and the pH of the acidizing treatment fluid can be used. One of ordinary skill in the art with the benefit of this disclosure will recognize when such crosslinkers are appropriate and what particular crosslinker will be most suitable.

The viscosified treatment fluids of the present invention also can comprise breakers capable of reducing the viscosity of the viscosified treatment fluid at a desired time. Examples of such suitable breakers for viscosified treatment fluids of the present invention include, but are not limited to, sodium chlorites, hypochlorites, perborate, persulfates, peroxides, including organic peroxides. Other suitable breakers include, but are not limited to, suitable acids and peroxide breakers, as well as enzymes that can be effective in breaking xanthan and compatible with HF acid. Preferred examples of peroxide breakers include tert-butyl hydroperoxide and tert-amyl hydroperoxide. A breaker can be included in a viscosified treatment fluid of the present invention in an amount and form sufficient to achieve the desired viscosity reduction at a desired time. The breaker can be formulated to provide a delayed break, if desired. For example, a suitable breaker can be encapsulated if desired. Suitable encapsulation methods are known to those skilled in the art. One suitable encapsulation method that can be used involves coating the chosen breakers with a material that will degrade when downhole so as to release the breaker when desired. Resins that can be suitable include, but are not limited to, polymeric materials that will degrade when downhole. The terms “degrade,” “degradation,” or “degradable” refer to both the two relatively extreme cases of hydrolytic degradation that the degradable material may undergo, i.e., heterogeneous (or bulk erosion) and homogeneous (or surface erosion), and any stage of degradation in between these two. This degradation can be a result of, inter alia, a chemical or thermal reaction or a reaction induced by radiation. Suitable examples include, but are not limited to, polysaccharides such as dextran or cellulose; chitins; chitosans; proteins; aliphatic polyesters; poly(lactides); poly(glycolides); poly(ε-caprolactones); poly(hydroxybutyrates); poly(anhydrides); aliphatic polycarbonates; orthoesters, poly(orthoesters); poly(amino acids); poly(ethylene oxides); and polyphosphazenes. If used, a breaker should be included in a composition of the present invention in an amount sufficient to facilitate the desired reduction in viscosity in a viscosified treatment fluid. For instance, peroxide concentrations that can be used vary from about 0.05 to about 30 gallons of peroxide per 1,000 gallons of the viscosified treatment fluid.

Optionally, a viscosified treatment fluid of the present invention can contain an activator or a retarder, inter alia, to optimize the break rate provided by the breaker. Any known activator or retarder that is compatible with the particular breaker used and compatible with HF acid is suitable for use in the present invention. Examples of such suitable activators include, but are not limited to, acid generating materials, chelated iron, copper, cobalt, and reducing sugars. Examples of suitable retarders include sodium thiosulfate and diethylene triamine. In some embodiments, the sodium thiosulfate can be used in a range of from about 1 to about 100 lbs. per 1,000 gallons of viscosified treatment fluid. A preferred range can be from about 5 to about 20 lbs per 1,000 gallons. An artisan of ordinary skill with the benefit of this disclosure will be able to identify a suitable activator or retarder and the proper concentration of such activator or retarder for a given application.

The viscosified treatment fluids of the present invention also can comprise suitable fluid loss control agents. Such fluid loss control agents can be particularly useful when a viscosified treatment fluid of the present invention is being used in a fracturing operation. This can be due in part to xanthan's potential to leak off into formation. Any fluid loss agent that is compatible with the viscosified treatment fluid is suitable for use in the present invention. Examples include, but are not limited to, starches, silica flour, and diesel dispersed in fluid. Another example of a suitable fluid loss control additive is one that comprises a degradable material. Suitable degradable materials include degradable polymers. Specific examples of suitable polymers include polysaccharides such as dextran or cellulose; chitins; chitosans; proteins; aliphatic polyesters; poly(lactides); poly(glycolides); poly(glycolide-co-lactides); poly(p-caprolactones); poly(3-hydroxybutyrates); poly(3-hydroxybutyrate-co-hydroxyvalerates); poly(anhydrides); aliphatic poly(carbonates); poly(orthoesters); poly(amino acids); poly(ethylene oxides); poly(phosphazenes); derivatives thereof; or combinations thereof. If included, a fluid loss additive should be added to a viscosified treatment fluid of the present invention in an amount of about 5 to about 50 pounds per 1,000 gallons of the viscosified treatment fluid. In certain preferred embodiments, the fluid loss additive can be included in an amount from about 15 to about 30 pounds per 1,000 gallons of the viscosified treatment fluid. For some liquid additives like diesel, these can be included in an amount from about 1% to about 20% by volume; in some preferred embodiments, these can be included in an amount from about 3% to about 10% by volume.

If in a particular application a chosen viscosified treatment fluid is experiencing a viscosity degradation a stabilizer might be useful and can be included in the fluid. One example of a situation where a stabilizer might be beneficial is where the BHT of the well bore is sufficient by itself to break the viscosified treatment fluid with the use of a breaker. Suitable stabilizers include, but are not limited to, sodium thiosulfate. Such stabilizers can be useful when the viscosified treatment fluids of the present invention are utilized in a subterranean formation having a temperature above about 150° F. If included, a stabilizer can be added in an amount of from about 1 lb to about 50 lb per 1,000 gal of viscosified treatment fluid. In other embodiments, a stabilizer can be included in an amount of from about 5 to about 20 lb per 1,000 gal of viscosified treatment fluid.

Scale inhibitors can be added to the viscosified treatment fluids of the present invention, for example, when a viscosified treatment fluid of the present invention is not particularly compatible with the formation waters in the formation in which it is being used. Any scale inhibitor that is compatible with the viscosified treatment fluid in which it will be used in suitable for use in the present invention. An example of a preferred scale inhibitor is “LP55” from Halliburton Energy Services in Duncan, Okla. Another example of a preferred scale inhibitor is “FDP-S660-02” available from Halliburton Energy Services in Duncan, Okla. If used, a scale inhibitor should be included in an amount effective to inhibit scale formation. Suitable amounts of scale inhibitors to include in the viscosified treatment fluids of the present invention can range from about 0.05 to 10 gallons per about 1,000 gallons of the viscosified treatment fluid, more preferably from about 0.1 to 2 gallons per about 1,000 gallons of the viscosified treatment fluid.

Although not normally used in acidizing remediation procedures, any particulates such as proppant and/or gravel that are commonly used in subterranean operations can be used successfully in conjunction with the compositions and methods of the present invention. For example, resin and/or tackifier coated particulates can be suitable.

In one embodiment, the present invention provides a method of making a viscosified treatment fluid comprising the steps of: providing a brine of ammonium chloride; filtering the brine through a filter; dispersing a gelling agent that comprises a xanthan into the brine with adequate sheer to fully disperse the gelling agent therein to form a brine and gelling agent mixture; mixing the brine and gelling agent mixture; allowing the xanthan to fully hydrate in the brine and gelling agent mixture to form a viscosified treatment fluid; and filtering the viscosified treatment fluid.

In a more preferred embodiment, a viscosified treatment fluid of the present invention can be prepared according to the following process: providing a brine of ammonium chloride having a suitable density; adding optional chemical such as biocides, chelating agents, pH control agents, and the like that are compatible with HF acid; filtering the brine through a 2 .mu. filter or a finer filter; dispersing the gelling agent comprising a xanthan into the brine with adequate sheer to fully disperse polymer therein; mixing the fluid until the xanthan is fully hydrated; shearing the viscosified treatment fluid to fully disperse any microglobs of xanthan polymer (e.g., a relatively small agglomeration of unhydrated xanthan polymer at least partially surrounded by a dense layer of at least partially hydrated xanthan polymer) that have not fully dispersed; filtering the fluid; and adding any additional optional ingredients including surfactants, breakers, activators, retarders, and the like.

In one embodiment, the present invention provides a method of treating a portion of a subterranean formation comprising the steps of: providing a viscosified treatment fluid that comprises a brine of ammonium chloride, HF, and a gelling agent that comprises a xanthan or derivative or xanthan; and treating the portion of the subterranean formation.

In another embodiment, the present invention provides a method of treating a portion of a subterranean formation comprising: providing a viscosified treatment fluid that comprises freshwater, HF, and a gelling agent that comprises a xanthan or derivative of xanthan; and treating the portion of the subterranean formation.

The viscosified treatment fluids of the present invention can be useful in subterranean acid fracturing operations. In one embodiment, the present invention provides a method of fracturing a portion of a subterranean formation comprising: providing a viscosified fracturing fluid that comprises a brine, HF, and a gelling agent that comprises a xanthan or a derivative of xanthan; and contacting the portion of the subterranean formation with the viscosified fracturing fluid at a sufficient pressure to create or enhance at least one fracture in the subterranean formation.

In another embodiment, the present invention provides a method of producing hydrocarbons from a subterranean formation comprising using a viscosified treatment fluid that comprises a brine, HF, and a gelling agent that comprises a xanthan or a derivative or xanthan in a completion or a servicing operation.

In another embodiment, the present invention provides a method of producing hydrocarbons from a subterranean formation comprising using a viscosified treatment fluid that comprises a brine, HF, and a gelling agent that comprises a xanthan or a derivative or xanthan in a completion or a servicing operation, and the subterranean formation has a bottom hole temperature of from about 30° F. to about 300° F.

In another embodiment, the present invention provides a viscosified treatment fluid comprising freshwater, HF, and a gelling agent that comprises a xanthan or a derivative of xanthan.

What is claimed is:

1. A method of acidizing a portion of a subterranean formation, the method comprising the steps of:
(A) forming a viscosified treatment fluid comprising:
(i) water;
(ii) hydrogen fluoride or a controlled-release source of hydrogen fluoride; and
(iii) a gelling agent comprising a xanthan polymer or derivative thereof; and
(B) introducing the viscosified treatment fluid into the portion of the subterranean formation.

2. The method according to claim 1, wherein the water is a brine compatible with hydrogen fluoride.

3. The method according to claim 2, wherein the brine is an ammonium chloride brine.

4. The method according to claim 2, wherein the viscosified treatment fluid has a density of about 8.3 pounds per gallon to about 19.3 pounds per gallon.

5. The method according to claim 1, wherein the hydrogen fluoride is included in the viscosified treatment fluid in an amount from about 0.5% to about 10% by weight of the water.

6. The method according to claim 1, wherein the gelling agent comprises: purified xanthan polymer.

7. The method according to claim 1, wherein the gelling agent is included in the viscosified treatment fluid in an amount from about 20 lbs to about 100 lbs per 1,000 gallons of the viscosified treatment fluid.

8. The method according to claim 1, wherein the viscosified treatment fluid further comprises: a breaker for breaking the gelling agent.

9. The method according to claim 5, wherein the breaker comprises: sodium perborate.

10. The method according to claim 1, wherein the portion of the subterranean formation has a bottom hole temperature of from about 30° F. to about 300° F.

11. The method according to claim 1, wherein the viscosified treatment fluid further comprises a salt, a pH control additive, a surfactant, a breaker, a bactericide, a crosslinker, a fluid loss control agent, a stabilizer, a chelant, a scale inhibitor, a corrosion inhibitor, a non-emulsifier, a surfactant, or a combination thereof.

12. The method according to claim 11, wherein the salt is ammonium chloride.

13. The method according to claim 11 wherein the crosslinker comprises a potassium derivative, a ferric iron derivative, or a magnesium derivative.

14. The method according to claim 11, wherein the breaker is an acid, an acid generating material, a peroxide, or an enzyme.

15. The method according to claim 11, wherein the breaker is encapsulated and comprises a coating.

16. The method according to claim 15, wherein the coating comprises a degradable material.

17. The method according to claim 16, wherein the degradable material is a polysaccharide, a chitin, a chitosan, a protein, an aliphatic poly(ester), a poly(lactide), a poly(glycolide), a poly(ε-caprolactone), a poly(hydroxybutyrate), a poly(anhydride), an aliphatic polycarbonate, an orthoester, a poly(orthoester), a poly(amino acid), a poly(ethylene oxide), a poly(phosphazene), a derivative thereof, or a combination thereof.

18. The method according to claim 11, wherein the fluid loss control agent is included in an amount of from about 5 lbs to about 50 lbs per 1,000 gals of the viscosified treatment fluid.

19. The method according to claim 11, wherein the fluid loss control agent comprises silica flour, a starch, diesel, or a degradable material.

20. The method according to claim 1, wherein the viscosified treatment fluid further comprises a breaker and an activator or a retarder.

21. The method according to claim 1, wherein the step of introducing the viscosified treatment fluid is without the use of coiled tubing.

22. The method according to claim 1, wherein the step of introducing the viscosified treatment fluid comprises bullheading.

23. The method according to claim 1, wherein the viscosified treatment fluid is without particulate.

24. The method according to claim 1, wherein the portion of the subterranean formation is penetrated by a wellbore, wherein the wellbore is horizontal, open hole, gravel packed, or has a slotted liner.

25. A method of producing hydrocarbons from a subterranean formation penetrated by a wellbore, the method comprising the steps of:
(A) forming a viscosified treatment fluid comprising:
(i) a brine compatible with hydrogen fluoride,
(ii) hydrogen fluoride or a controlled-release source of hydrogen fluoride, and
(iii) a gelling agent that comprises a xanthan or derivative thereof in a completion or a servicing operation;
(B) introducing the viscosified treatment fluid into the portion of the subterranean formation through the wellbore; and
(C) producing hydrocarbons from the subterranean formation.

26. The method according to claim 25, wherein the hydrogen fluoride is included in the viscosified treatment fluid in an amount from about 0.5% to about 10% by weight of the brine.

27. A composition for use in treating a subterranean formation, the composition comprising:
(A) water;
(B) hydrogen fluoride or a controlled-release source of hydrogen fluoride; and
(C) a gelling agent that comprises a xanthan or derivative thereof.

28. The composition according to claim 27, further comprising: ammonium chloride.
